(19) United States
(12) Patent Application Publication
(10) Pub. No.: US 2026/0329623 A1
(43) Pub. Date: Oct. 22, 2026

(54) SOURCE ASSISTED INTERRUPT REQUEST (IRQ) PRIORITIZATION

(71) Applicant: QUALCOMM Incorporated, San Diego, CA (US)

(72) Inventors: Dinesh Kumar CHOUDHARY, Tonk (IN); Sai Sumanth MANCHUKONDA, Rangareddy (IN); Maulik SHAH, Hyderabad (IN); Sai Sneha Venkata YESANTARAO, Hyderabad (IN); Prasad Rao KOLETI, Hyderabad (IN)

(21) Appl. No.: 19/183,692

(22) Filed: Apr. 18, 2025

(51) Int. Cl. G06F 9/48

(52) U.S. Cl. CPC G06F 9/4818; G06F 9/4831

(57) ABSTRACT

A method for interrupt request (IRQ) prioritization includes receiving, at a register space, from all sources of interrupts on a merged interrupt line, a priority for each of the interrupts on the merged interrupt line. The priorities are dynamically updated. The method also includes receiving a first triggered IRQ on the merged interrupt line. The method further includes prioritizing the first triggered IRQ in accordance with the priorities. The method still further includes servicing the first triggered IRQ in accordance with the priorities.

### FIELD OF THE DISCLOSURE

Aspects of the present disclosure generally relate to computer systems, and more particularly to source assisted interrupt request (IRQ) prioritization.

### BACKGROUND

Interrupt handling is a process in computer systems where a processing unit, such as a central processing unit (CPU), temporarily halts current tasks to address a specific event or condition requiring more immediate attention. The event or condition is referred to as an interrupt. Interrupts may be generated in response to external events, such as input from a user or a network packet arrival, and/or internal events, such as the expiration of a timer or a software condition being satisfied. When an interrupt occurs, the processing unit saves the processing unit’s current state and executes a specified portion of program code associated with the interrupt, referred to as an interrupt service routine (ISR) or interrupt handler. The processing unit, executing the interrupt service routine, services the interrupt by performing actions such as reading input data and transmitting hardware signals. Upon completion, the processing unit restores the previous state and resumes prior tasks. Interrupt handling enables processing units to manage multiple tasks and respond to real-time events. It would be desirable to efficiently handle dynamic prioritization of interrupts.

### SUMMARY

In aspects of the present disclosure, a method for interrupt request (IRQ) prioritization includes receiving, at a register space, from all sources of interrupts on a merged interrupt line, a priority for each of the interrupts on the merged interrupt line. The priorities are dynamically updated. The method also includes receiving a first triggered IRQ on the merged interrupt line. The method further includes prioritizing the first triggered IRQ in accordance with the priorities. The method still further includes servicing the first triggered IRQ in accordance with the priorities.

Other aspects of the present disclosure are directed to an apparatus. The apparatus has one or more memories and one or more processors coupled to the one or more memories. The processor(s) is configured to receive, at a register space, from all sources of interrupts on a merged interrupt line, a priority for each of the interrupts on the merged interrupt line. The priorities are dynamically updated. The processor(s) is also configured to receive a first triggered IRQ on the merged interrupt line. The processor(s) is further configured to prioritize the first triggered IRQ in accordance with the priorities. The processor(s) is still further configured to service the first triggered IRQ in accordance with the priorities.

In other aspects of the present disclosure, a non-transitory computer-readable medium with program code recorded thereon is disclosed. The program code is executed by a processor and includes program code to receive, at a register space, from all sources of interrupts on a merged interrupt line, a priority for each of the interrupts on the merged interrupt line. The priorities are dynamically updated. The program code also includes program code to receive a first triggered IRQ on the merged interrupt line. The program code further includes program code to prioritize the first triggered IRQ in accordance with the priorities. The program code still further includes program code to service the first triggered IRQ in accordance with the priorities.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system-on-a-chip (SOC), in accordance with various aspects of the present disclosure.

FIG. 2 is a block diagram illustrating prioritization among different shared peripheral interrupts (SPIs) with merged interrupt lines, in accordance with various aspects of the present disclosure.

FIG. 3 is a block diagram illustrating one-to-one (1:1) interrupt connectivity to a controller, in accordance with various aspects of the present disclosure.

FIG. 4 is a block diagram illustrating merged interrupt connectivity to a controller, in accordance with various aspects of the present disclosure.

FIG. 5 is a timeline illustrating core execution with various interrupt solutions, in accordance with various aspects of the present disclosure.

FIG. 6 is a block diagram illustrating dynamic interrupt prioritization, in accordance with various aspects of the present disclosure.

FIG. 7 is a block diagram illustrating another example of source aware dynamic interrupt prioritization, in accordance with various aspects of the present disclosure.

FIG. 8 is a flow diagram illustrating an example process performed, for example, by a processor, in accordance with various aspects of the present disclosure.

FIG. 9 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Several aspects of interrupt priority handling will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

As described, interrupt handling is a process in computer systems where a processing unit, such as a central processing unit (CPU), temporarily halts current tasks to address a specific event or condition requiring more immediate attention. During the interrupt handling process, a subsystem may produce an interrupt identification (ID) value corresponding to a pending interrupt. The subsystem may transmit the interrupt ID value to an interrupt controller via a merged interrupt line. The interrupt controller then routes the interrupt to a CPU. The CPU may then execute an interrupt service routine (ISR) associated with the interrupt ID value.

Various aspects of the present disclosure are directed to interrupt handling, including the handling of shared peripheral interrupts (SPIs). Conventional systems for interrupt handling may include various subsystems. Examples of subsystems may include multiprocessors, hardware blocks, peripherals such as video devices and audio devices, and subsystem blocks. Additionally, each of the subsystems may include multiple sources. For instance, a video subsystem may include three interrupt sources and an audio device may include five interrupt sources.

With complex systems having multiple interrupt sources, it is difficult to have dedicated wired one-to-one (1:1) connectivity to an interrupt controller, such as a generic interrupt controller (GIC). A generic interrupt controller supports up to 1984 interrupts (hard-wired) from all shared sources. With connectivity devices, such as fifth generation (5G) cellular and wireless local area network (WLAN) devices, and different storage types, the number of interrupt lines is insufficient to accommodate all of the sources. Thus, different schemes, such as message-based interrupts or merged interrupts, may be employed. With merged interrupt handling, the servicing processor reads the status, determines the trigger type, and handles the interrupts accordingly.

For merged interrupt handling techniques, interrupts may be routed from subsystems to an interrupt controller via a single interrupt line, referred to as a merged interrupt line. For example, three separate interrupt sources within a video subsystem may transmit interrupts to a CPU via the interrupt controller. In this example, the three individual interrupts may each merge onto the single interrupt line as they are transmitted to the interrupt controller. At the CPU, a generic interrupt controller (GIC) receives the interrupts and performs an interrupt service routine (ISR) based on the interrupts. Interrupt service routines may also be referred to as interrupt handlers.

The interrupts each include an interrupt identification (ID) value or number. For interrupts transmitted from subsystems including multiple interrupt sources, multiple triggers may be merged into a single interrupt line with the same interrupt ID value. For example, interrupts transmitted from different sources within a video subsystem may each have an interrupt ID value of five. Because the generic interrupt controller receives the interrupts from a single interrupt line and the triggers each have the same interrupt ID value, the generic interrupt controller treats the individual triggers as a single interrupt because the triggers are merged on a single line. The generic interrupt controller is therefore unable to prioritize the individual interrupts, and instead manages the individual interrupts as having an equal priority level. The generic interrupt controller may also receive additional interrupts from different subsystems. The additional interrupts are each associated with their own interrupt ID value and priority level.

At the generic interrupt controller, interrupt handling software acknowledges received interrupts based on the priority of interrupts, and the CPU executes an interrupt service routine specific to the interrupt. For example, an interrupt from a first subsystem having an interrupt ID value of five may be associated with a priority value of 0. An interrupt from a second subsystem having an interrupt ID value of four may be associated with a priority value of 1. In this example, the generic interrupt controller may first execute the interrupt service routine for the first subsystem’s interrupt because the interrupt from the first subsystem is associated with a lower priority value. With multiple interrupt lines merged into a single hard-wired interrupt request (IRQ) line, aggregated priority value across all merged lines is merged into a single priority value at the controller level, resulting in a less than optimal handling of interrupts. Aspects of the present disclosure address the challenges associated with interrupt prioritization in merged lines. Solutions are introduced for efficient handling of merged interrupts based on dynamic source recommendations, with results similar to 1:1 connected interrupt prioritization.

Aspects of the present disclosure introduce source aware dynamic interrupt prioritization. In these aspects, a priority of required triggers is configured at initialization. Dynamically, when a trigger is raised, the IRQ value/number and associated priority are sent to an interrupt priority propagator (IPP) for updating the configuration at the interrupt controller. The interrupt priority propagator receives priorities and corresponding IRQ values/numbers from each source. Packets containing the information may be received when an interrupt is triggered. The interrupt priority propagator then updates priorities in the interrupt controller’s register space. Accordingly, the interrupt is handled with the same priority as dynamically indicated by the source. With the proposed solution, triggers from different merged line controllers are prioritized dynamically based on trigger type.

Particular aspects of the subject matter described in this disclosure can be implemented to realize one or more of the following potential advantages. In some examples, the described techniques, such as dynamically prioritizing interrupts from merged lines, enable prioritization intelligence to be implemented at the source, rather than at a servicing entity, such as a processor. Another advantage is that multiple or all interrupts at a source can be merged and still efficiently delivered/serviced as in a 1:1 connectivity configuration, reducing hardware cost compared to 1:1 hard-wire connectivity. Yet another advantage of efficient handling of interrupts in merged interrupt environments is power and performance improvements.

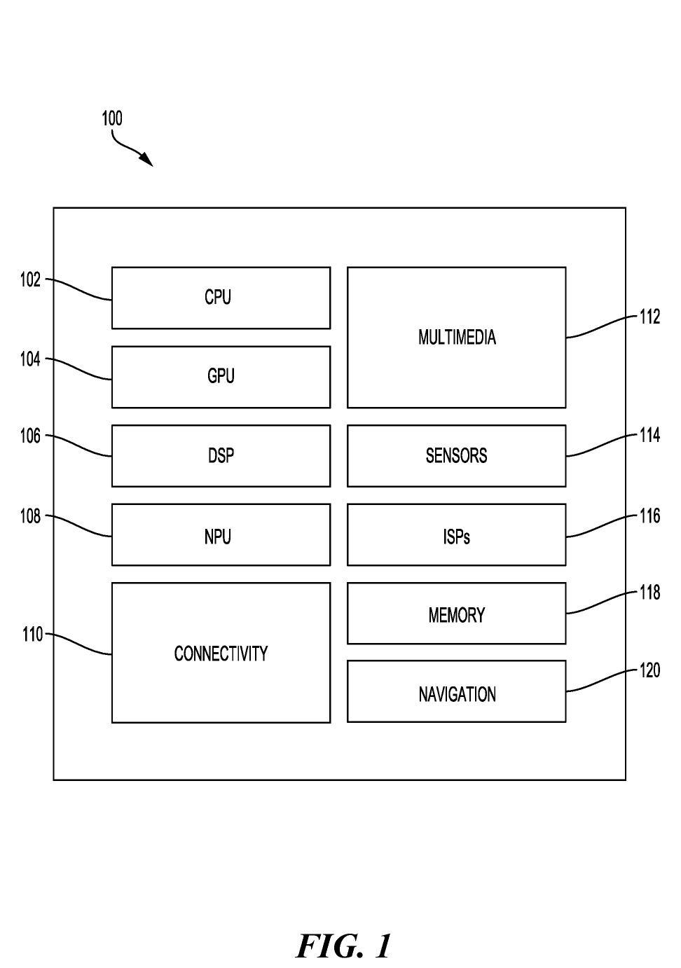

FIG. 1 illustrates an example implementation of a system-on-a-chip (SOC) 100, which may include a central processing unit (CPU) 102 or a multi-core CPU configured for interrupt handling. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the CPU 102 may include code to receive, at a register space, from all sources of interrupts on a merged interrupt line, a priority for each of the interrupts on the merged interrupt line. The priorities are dynamically updated. The instructions loaded into the CPU 102 may include code to receive a first triggered IRQ on the merged interrupt line. The instructions loaded into the CPU 102 may include code to prioritize the first triggered IRQ in accordance with the priorities. The instructions loaded into the CPU 102 may include code to service the first triggered IRQ in accordance with the priorities

According to aspects of the present disclosure, an apparatus includes a generic interrupt controller and a processor. The apparatus may include means for receiving, means for prioritizing, means for servicing, and means for handling. For example, the means receiving means, the prioritizing means, the servicing means, and the handling means may be any of the CPU 102, GPU 104, DSP 106, NPU 108, ISP 116, IPP 630, 730, processor 620, 720, or interrupt controller 610, 710. In other aspects, the aforementioned means may be any structure or any material configured to perform the functions recited by the aforementioned means.

Various aspects of the present disclosure are directed to interrupt handling, including the handling of shared peripheral interrupts (SPIs). Conventional systems for interrupt handling may include various subsystems. Examples of subsystems may include multiprocessors, hardware blocks, peripherals such as video devices and audio devices, and subsystem blocks. Additionally, each of the subsystems may include multiple sources. For instance, a video subsystem may include three interrupt sources and an audio device may include five interrupt sources.

With complex systems having multiple interrupt sources, it is difficult to have dedicated wired 1:1 connectivity to an interrupt controller, such as a generic interrupt controller (GIC). A generic interrupt controller supports up to 1984 interrupts (hard-wired) from all shared sources. With connectivity devices, such as 5G and wireless local area network (WLAN) devices, and different storage types, the number of interrupt lines is insufficient to accommodate all of the sources. Thus, different schemes, such as message-based interrupts or merged interrupts, may be employed.

Message-based interrupts are latency prone, as the technique specifies device/interrupt information and routing information from off-chip memory (e.g., dynamic random access memory (DRAM)) to be processed via a queue. In contrast, hard-wired interrupts are delivered to the interrupt controller with reduced overhead.

Merging multiple interrupt lines as sources and delivering to a generic interrupt controller (GIC) as a single summary interrupt line is preferred compared to message-based interrupt processing. With merged interrupt handling, the servicing processor reads the status, determines the trigger type, and handles the interrupts accordingly.

For merged interrupt handling techniques, interrupts may be routed from subsystems to a CPU via a single interrupt line, referred to as a merged interrupt line. For example, three separate interrupt sources within a video subsystem may transmit interrupts to a CPU. In this example, the three individual interrupts may each merge onto the single interrupt line as they are transmitted to the CPU. At the CPU, a generic interrupt controller (GIC) receives the interrupts and performs an interrupt service routine (ISR) based on the interrupts. Interrupt service routines may also be referred to as interrupt handlers.

The interrupts each include an interrupt identification (ID) value or number. For interrupts transmitted from subsystems including multiple interrupt sources, each interrupt may have the same interrupt ID value as multiple triggers are merged in a single line with a single interrupt ID value. For example, interrupts transmitted from different sources within a video subsystem may each have an interrupt ID value of five. Because the generic interrupt controller receives the interrupts from a single interrupt line and the interrupts each have the same interrupt ID value, the generic interrupt controller treats the individual interrupts as a single interrupt. The generic interrupt controller is therefore unable to prioritize the individual interrupts, and instead manages the individual interrupts as having an equal priority level. The generic interrupt controller may also receive additional interrupts from different subsystems. The additional interrupts are each associated with their own interrupt ID value and priority level.

At the generic interrupt controller, interrupt handling software acknowledges received interrupts based on the priority of interrupts, and the CPU executes an interrupt service routine specific to the interrupt. For example, an interrupt from a first subsystem having an interrupt ID value of five may be associated with a priority value of 1. An interrupt from a second subsystem having an interrupt ID value of four may be associated with a priority value of 2. In this example, the generic interrupt controller may first execute the interrupt service routine for the first subsystem’s interrupt because the interrupt from the first subsystem is associated with a higher priority value.

The following example describes conventional merged interrupt handling. In this example, an exception is raised within a CPU, such as the CPU 102 described with respect to FIG. 1. Although the exception could be a fast interrupt request (FIQ) or a standard interrupt request (IRQ), the exception in this example is a standard interrupt request. A generic interrupt controller within the CPU implements an interrupt vector table that associates a list of interrupt handlers with a list of interrupt requests. Using the interrupt vector table, execution jumps to a top interrupt handler associated with the pending interrupt. The interrupt ID value for the pending interrupt is stored in a register at the CPU interface. For instance, the interrupt ID value may be stored in an interrupt acknowledgment register, such as a generic interrupt controller CPU interface interrupt acknowledgment register (GICC_IAR).

A CPU may execute an interrupt service routine upon receiving an interrupt from a subsystem. As part of a parent interrupt service routine, the CPU may read an interrupt register within the subsystem to determine the interrupt sources within the subsystem that have pending interrupts. The CPU may then branch execution based on the pending interrupts. Based on source and further interrupt type, all interrupts are recommended to be delivered/serviced with certain priorities, which are handled by interrupt controller routing algorithms based on a configuration present at the interrupt controller.

With multiple interrupt lines merged into a single hard-wired interrupt request (IRQ) line, aggregated priority across all merged lines is merged into a single priority at the controller level, resulting in a less than optimal handling of interrupts.

Aspects of the present disclosure address the challenges associated with interrupt prioritization in merged lines. Solutions are introduced for efficient handling of merged interrupts based on dynamic source recommendations, with results similar to 1:1 connected interrupt prioritization.

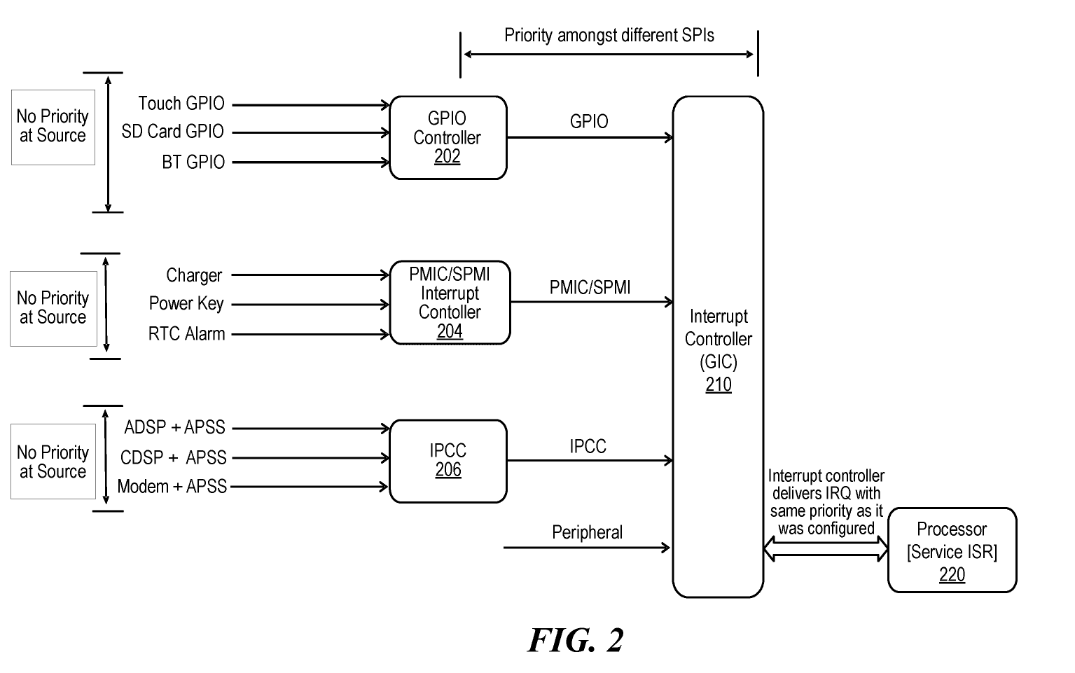

FIG. 2 is a block diagram illustrating prioritization among different shared peripheral interrupts (SPIs) with merged interrupt lines, in accordance with various aspects of the present disclosure. In the example of FIG. 2, a general purpose input/output (GPIO) controller 202 receives interrupt lines from a touch GPIO, a secure digital (SD) card GPIO, and a BLUETOOTH (BT) GPIO. A power management integrated circuit (PMIC)/system power management interface (SPMI) interrupt controller 204 receives interrupt lines from a charger, a power key, and a real time clock (RTC) alarm. An interprocessor communications controller (IPCC) 206 receives interrupt lines from an audio digital signal processor (ADSP) and application processor subsystem (APSS), a compute DSP (CDSP) and APSS, and a modem and APSS. An interrupt controller 210, (e.g., a GIC) receives a merged interrupt line from the GPIO controller 202, the PMIC/SPMI interrupt controller 204, and the IPCC 206, and also a 1:1 interrupt line from a peripheral. The interrupt controller 210 delivers interrupt requests (IRQs) to a processor 220, which services the ISRs.

In a first example described with respect to FIG. 2, it is assumed that the PMIC/SPMI interrupt controller 204 has a higher priority than the GPIO controller 202. In a first example sequence of IRQs, an RTC alarm is handled over a PMIC/SPMI line from the PMIC/SPMI interrupt controller 204. A user then presses a touch screen, generating a touch GPIO IRQ. Processing of the touch IRQ is delayed in this example because the PMIC/SPMI interrupt controller 204 has a higher priority than the GPIO controller 202. The GPIO summary from the GPIO controller 202 may need a higher priority in order to prevent the RTC alarm IRQ from blocking processing of the touch GPIO IRQ. Currently, peripherals cannot change priority depending on the source of the IRQ.

In a second example described with respect to FIG. 2, it is assumed that the PMIC/SPMI interrupt controller 204 has a lower priority than the GPIO controller 202. In a second example sequence of IRQs, an RTC alarm IRQ is handled over the PMIC/SPMI line from the PMIC/SPMI interrupt controller 204. A user then inserts an SD card, generating an SD card GPIO IRQ. Processing of the RTC alarm IRQ is delayed in this example because the PMIC/SPMI interrupt controller 204 has a lower priority than the GPIO controller 202. The GPIO summary from the GPIO controller 202 should be a lower priority in order to prevent the RTC IRQ from being preempted by the less important SD card GPIO IRQ. Currently, peripherals cannot change priority depending on the source of the IRQ.

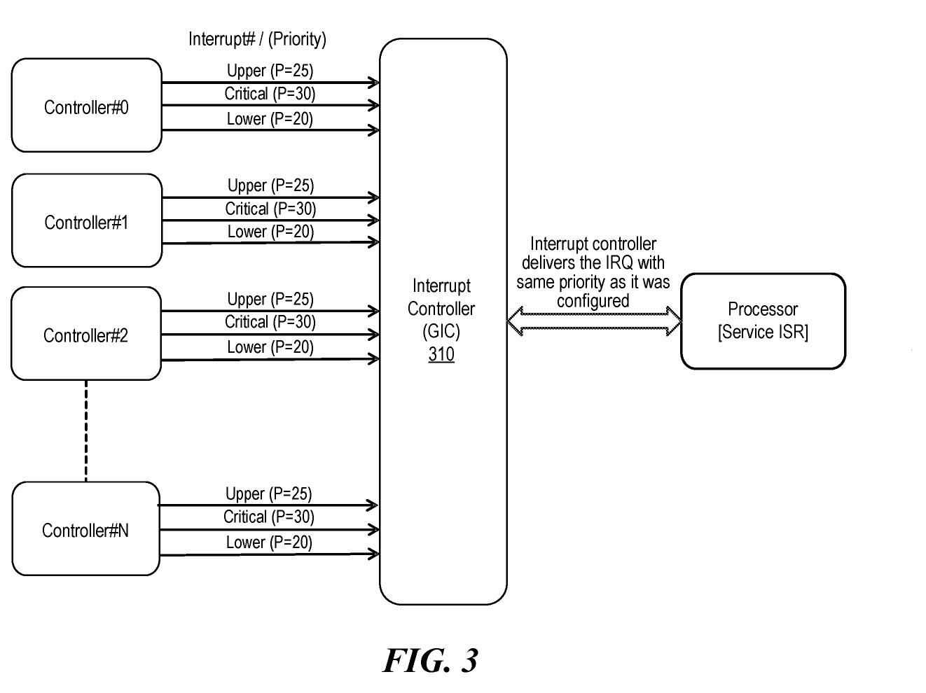

FIG. 3 is a block diagram illustrating one-to-one (1:1) interrupt connectivity to a controller, in accordance with various aspects of the present disclosure. In the example of FIG. 3, different peripherals or controllers (e.g., controller#0,…controller#N) assert multiple interrupts for different functionalities expected to be delivered/handled with associated priorities. An interrupt controller 310 (e.g., a GIC) receives three hard-wired interrupts from the controllers (e.g., controller#0,…controller#N). From each of the controllers (e.g., controller#0,…controller#N), an upper interrupt with priority value of 25 (P=25), a lower interrupt with priority value of 20 (P=20), and a critical interrupt with priority value of 30 (P=30) are present. Given the limited number of dedicated lines, other techniques should allow the interrupt controller 310 to support the increasing complexities of computing devices.

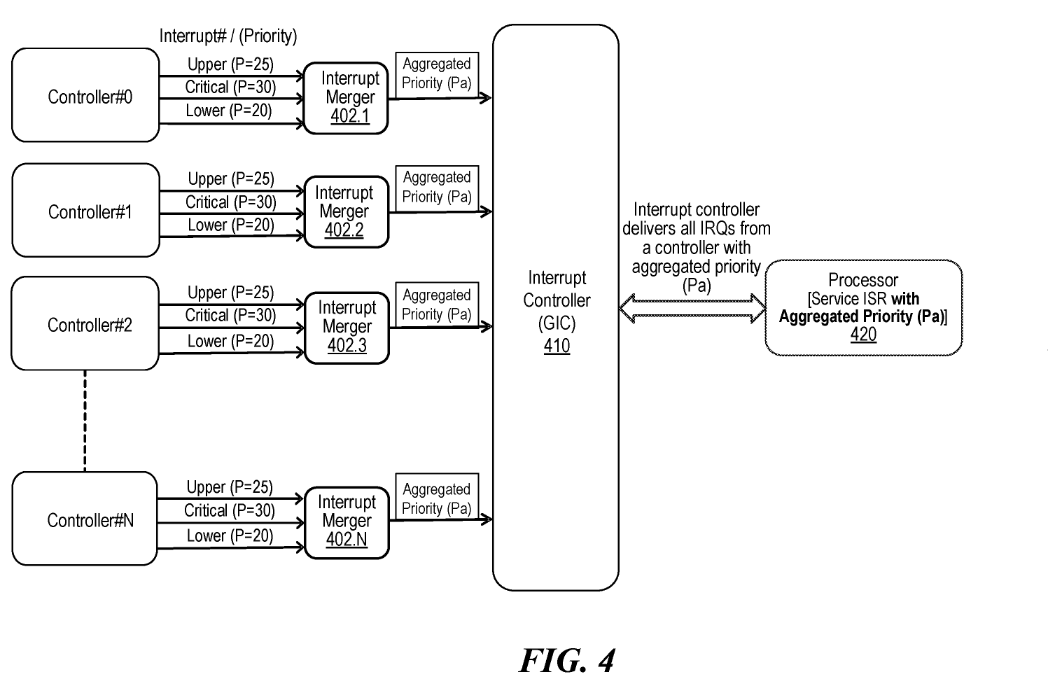

Accordingly, interrupt lines may be merged at a peripheral with functionalities intact at a controller/processor servicing the interrupt service routines (ISRs) for IRQ handling. FIG. 4 is a block diagram illustrating merged interrupt connectivity to a controller, in accordance with various aspects of the present disclosure. As seen in the example of FIG. 4, multiple interrupts from each source (e.g., controller#0,… controller#N) are merged into one line at an interrupt merger 402 (e.g., 402.1,…402.N). Each single line from the interrupt mergers 402 (e.g., 402.1,… 402.N) is connected to an interrupt controller 410. The interrupt controller 410 receives an aggregated priority (Pa) from each interrupt merger 402 (e.g., 402.1,…402.N). Thus, a processor 420 services an ISR in accordance with the aggregated priority Pa. In the implementation of FIG. 4, 1:1 connectivity is reduced by a number of triggers generated at a specific source. Three triggers in the example of FIG. 4 result in an overall 1:1 connectivity reduction of 67%. This implementation does not retain priority for handling interrupts at the controller 410 and while servicing the interrupts. This implementation also does not have 1:1 connectivity. It would be desirable to retain priority and allow efficient handling.

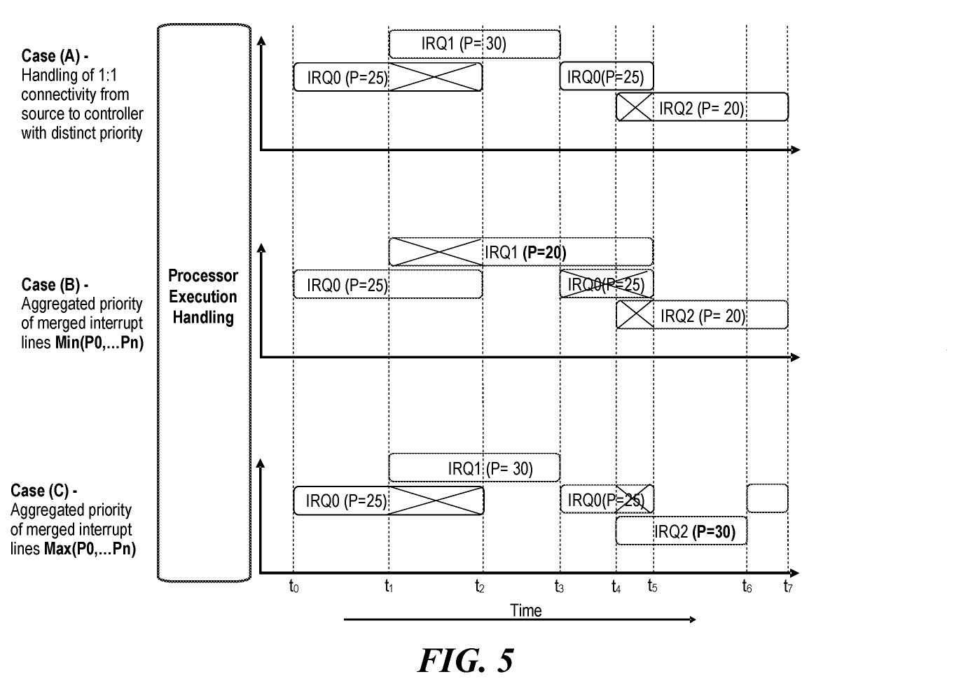

FIG. 5 is a timeline illustrating core execution with various interrupt solutions, in accordance with various aspects of the present disclosure. In the example of FIG. 5, two different interrupts from a same source are triggered at different times while a processor is already handling an interrupt. In the example of FIG. 5, the processor is currently handling an interrupt (IRQ0) with priority value of 25 at time t0. A first IRQ (IRQ1) with priority value of 30 arrives at time t1. A second IRQ (IRQ2) with a priority value of 20 is asserted at time t4.

In a first case (Case(A)), optimal handling occurs where the first IRQ (IRQ1) preempts the currently processing IRQ (IRQ0), which then completes at time t3. The second IRQ (IRQ2) is delayed until the current interrupt (IRQ0) completes at time t5. The first case is based on 1:1 connectivity from the source to the controller with distinct priorities.

In a second case (Case(B)), the aggregated priority of merged interrupt lines is a minimum among all interrupts. Thus, the first IRQ (IRQ1) is serviced at time t2, after the current IRQ (IRQ0) completes processing. Thus, handling of the first IRQ is not desirable.

In a third case (Case(C)), aggregated priority is based on a maximum among all merged lines. In the third case, the current interrupt (IRQ0) does not complete until time t7 because the second interrupt (IRQ2) at time t4 preempts processing of the current interrupt (IRQ0).

Aspects of the present disclosure introduce source aware dynamic interrupt prioritization. In these aspects, a priority of required triggers is configured at initialization. Dynamically, when a trigger is raised, the IRQ number and associated priority are sent to an interrupt priority propagator (IPP) for updating the configuration at the interrupt controller. The interrupt is then handled with the same priority as dynamically indicated by the source. With the proposed solution, triggers from different merged line controllers (e.g., the GPIO controller, PMIC/SPMI interrupt controller, or IPCC) are prioritized dynamically based on trigger type.

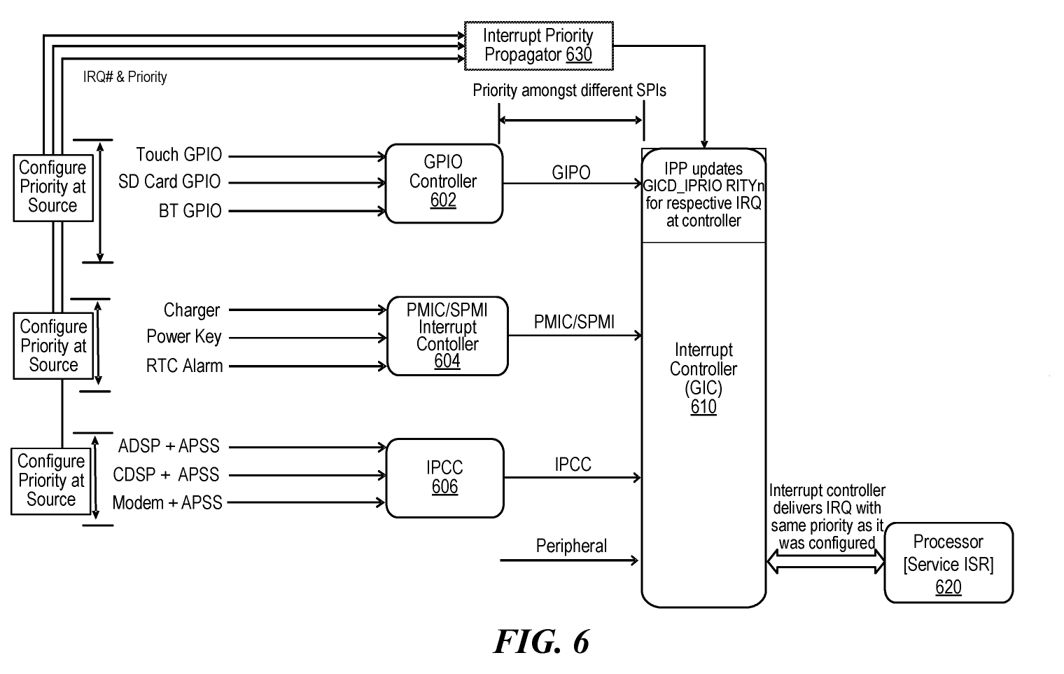

FIG. 6 is a block diagram illustrating dynamic interrupt prioritization, in accordance with various aspects of the present disclosure. In the example of FIG. 6, a general purpose input/output (GPIO) controller 602 receives interrupt lines from sources such as a touch GPIO, a secure digital (SD) card GPIO, and a BLUETOOTH (BT) GPIO. A power management integrated circuit (PMIC)/system power management interface (SPMI) interrupt controller 604 receives interrupt lines from sources such as a charger, a power key, and a real time clock (RTC) alarm. An interprocessor communications controller (IPCC) 606 receives interrupt lines from sources such as an audio digital signal processor (ADSP) and application processor subsystem (APSS), a compute DSP (CDSP) and APSS, and a modem and APSS. An interrupt controller 610, (e.g., a GIC) receives a merged interrupt line from the GPIO controller 602, the PMIC/SPMI interrupt controller 604, the IPCC 606, and a 1:1 interrupt line from a peripheral. The interrupt controller 610 delivers interrupt requests (IRQs) to a processor 620, which services the IRQs.

An interrupt priority propagator (IPP) 630 receives priorities and corresponding IRQ values/numbers from each source. Packets containing the information may be received when an interrupt is triggered. The interrupt priority propagator 630 updates priorities in the interrupt controller’s register space. For example, the interrupt priority propagator 630 may update a GICD_IPRIORITYn for respective IRQs at the interrupt controller 610. Thus, priority amongst different SPIs can be achieved. The interrupt priority propagator 630 receives the priorities and interrupt numbers via packets on separate lines from the merged interrupt lines of the GPIO controller 602, the PMIC/SPMI interrupt controller 604, and the IPCC 606. The interrupt priority propagator 630 may receive the priority information dynamically. In the example of FIG. 6, the touch GPIO interrupt in the GPIO controller 602 is prioritized above the RTC alarm in the PMIC/SPMI interrupt controller 604. Also, the RTC alarm is prioritized over the SD card GPIO in the GPIO controller 602, etc.

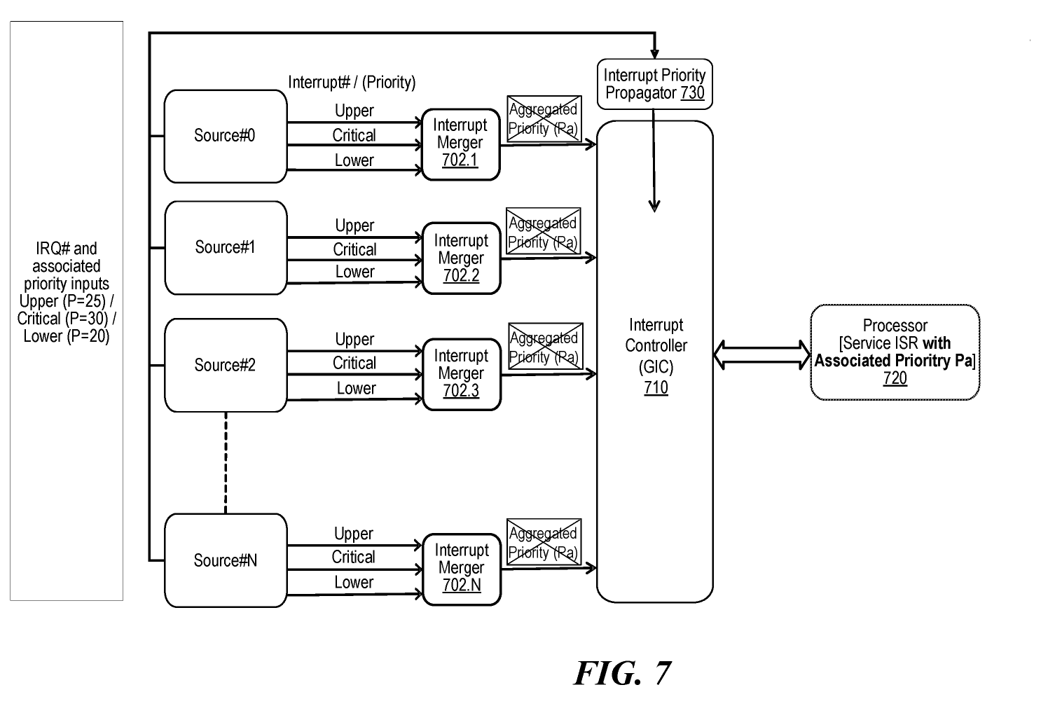

FIG. 7 is a block diagram illustrating another example of source aware dynamic interrupt prioritization, in accordance with various aspects of the present disclosure. As seen in the example of FIG. 7, multiple interrupts from a source (e.g., source#0,…source#N) are merged into a single line at interrupt mergers 702 (e.g., 702.1,… 702.N). Each single line is connected to an interrupt controller 710 (e.g., a GIC). Unlike the example shown in FIG. 4, in the example of FIG. 7, the interrupt controller 710 does not receive an aggregated priority (Pa) from each interrupt merger 702 (e.g., 702.1,…702.N). Rather, the interrupt controller 710 receives interrupt priorities from an interrupt priority propagator (IPP) 730.

More specifically, interrupt priorities from each source (e.g., source#0,…source#N) are written to the interrupt priority propagator 730 with the IRQ number. That is, each source (e.g., source#0,…source#N) transmits a packet to the interrupt priority propagator 730 when an interrupt is triggered. In the example of FIG. 7, the IRQ number and associated priority values are: upper priority value is 25, critical priority value is 30, and lower priority value is 20.

The interrupt priority propagator 730 converts the IRQ numbers and associated priorities to respective writes in the interrupt controller 710 for dynamic prioritization of asserted interrupts, based on the interrupt priority propagator 730 dynamically receiving the priorities from the sources (e.g., source#0,…source#N). A state machine of the interrupt priority propagator 730 updates the interrupt controller 710 based on the IRQ number and associated priority. The IRQ can then be delivered to the processor 720 with the associated priority. The processor 720 services each ISR in accordance with the associated priority received from the sources (e.g., source#0,…source#N).

According to the implementation shown in the example of FIG. 7, all interrupts in merged lines are each provisioned to be handled with different priorities, similar to a 1:1 hard-wired connectivity. No software interventions are needed for dynamic prioritization. Rather, the interrupt priority propagator 730 handles the dynamic prioritization. In case of a set of multiple merged triggers, maximum priorities of all merged triggers may be propagated to the interrupt controller 710 for IRQ servicing. Handling of interrupt priorities according to the implementation of FIG. 7 will be optimal, similar to the timeline of Case(A) shown in FIG. 5.

According to aspects of the present disclosure, the priority of an interrupt is written or updated by software routines at the source (e.g., source#0,…source#N). Once a source is updated about the associated priorities for different interrupts, the source can autonomously update the priorities without software intervention. Thus, prioritization intelligence is implemented at the source, rather than at the servicing entity, such as the processor 720.

Moreover, multiple or all interrupts at a source can be merged and still efficiently delivered/serviced as in a 1:1 connectivity configuration. Accordingly, hardware cost is reduced compared to 1:1 hard-wire connectivity from the source to the interrupt controller. With a merged scheme, software complexity is reduced, simplifying scaling across a kernel while maintaining upstream compliance. After cold-boot initialization, runtime prioritization of interrupts may be handled within hardware. Efficient handling of interrupts in merged interrupt environments provides power and performance improvements. The techniques extend to multiple interrupts from a source, allowing dynamic change in priorities, without software intervention. Sources may enforce power or performance friendly recommendations dynamically based on different system level recommendation.

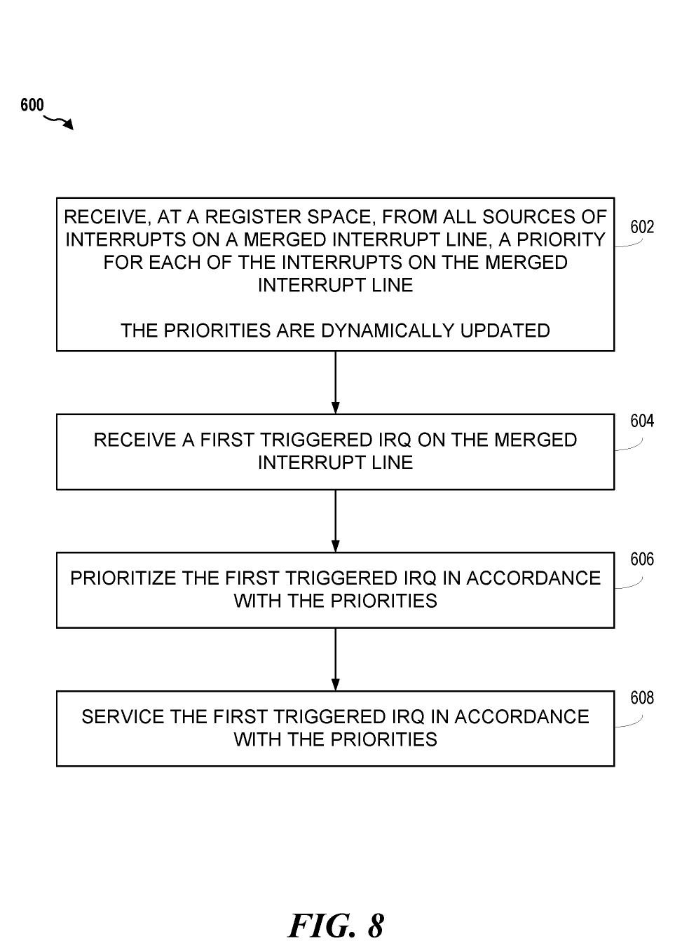

FIG. 8 is a flow diagram is a flow diagram illustrating an example process 800 performed, for example, by a processor, in accordance with various aspects of the present disclosure. The process 800 may be performed by one or more processors, such as the CPU 102, GPU 104, and/or other processing unit.

As shown in FIG. 8, in some aspects, the process 800 may include receiving, at a register space, from all sources of interrupts on a merged interrupt line, a priority for each of the interrupts on the merged interrupt line. The priorities are dynamically updated (block 802). In some aspects, the process 800 may include receiving a first triggered IRQ on the merged interrupt line (block 804). The priorities for each of the interrupts may be received via packets on a separate line from the merged interrupt line.

In some aspects, the process 800 may include prioritizing the first triggered IRQ in accordance with the priorities (block 806). In some aspects, the process 800 may include servicing the first triggered IRQ in accordance with the priorities (block 808).

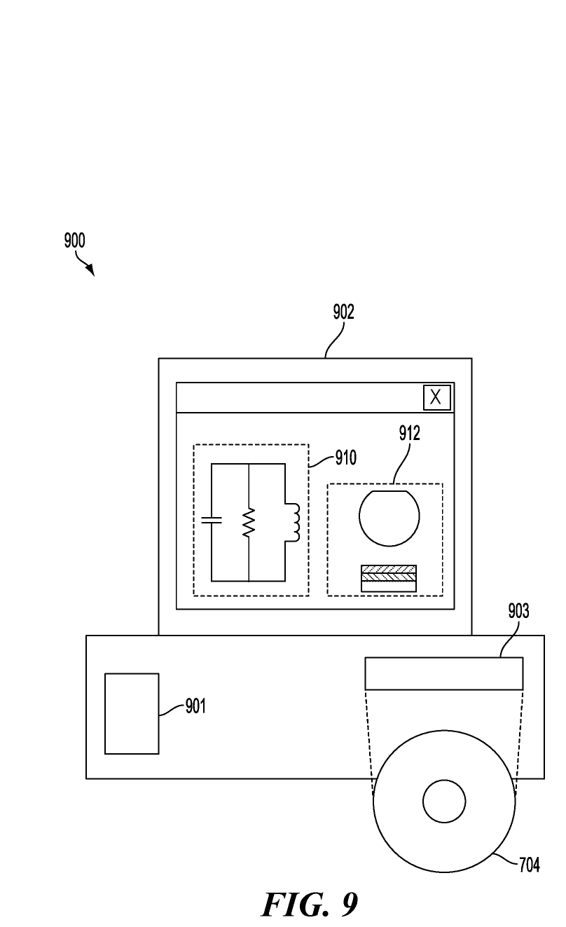

FIG. 9 is a block diagram illustrating a design workstation 900 used for circuit, layout, and logic design of a semiconductor component, such as the described source assisted interrupt prioritization. The design workstation 900 includes a hard disk 901 containing operating system software, support files, and design software such as Cadence or OrCAD. The design workstation 900 also includes a display 902 to facilitate design of a circuit 910 or a semiconductor component 912, such as the source assisted interrupt prioritization. A storage medium 904 is provided for tangibly storing the design of the circuit 910 or the semiconductor component 912 (e.g., the GICC_IAR1). The design of the circuit 910 or the semiconductor component 912 may be stored on the storage medium 904 in a file format such as GDSII or GERBER. The storage medium 904 may be a CD-ROM, DVD, hard disk, flash memory, or other appropriate device. Furthermore, the design workstation 900 includes a drive apparatus 903 for accepting input from or writing output to the storage medium 904.

Data recorded on the storage medium 904 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 904 facilitates the design of the circuit 910 or the semiconductor component 912 by decreasing the number of processes for designing semiconductor wafers.

### EXAMPLE ASPECTS

Aspect 1: A method of interrupt request (IRQ) prioritization, comprising: receiving, at a register space, from all sources of interrupts on a merged interrupt line, a priority for each of the interrupts on the merged interrupt line, the priorities being dynamically updated; receiving a first triggered IRQ on the merged interrupt line; prioritizing the first triggered IRQ in accordance with the priorities; and servicing the first triggered IRQ in accordance with the priorities.

Aspect 2: The method of Aspect 1, further comprising receiving, during system initialization, an initial configuration for the priorities of the interrupts on the merged interrupt line.

Aspect 3: The method of Aspect 1 or 2, in which the priorities for each of the interrupts are received via packets on a separate line from the merged interrupt line.

Aspect 4: The method of any of the preceding Aspects, further comprising receiving a maximum priority of a plurality of priorities in response to multiple IRQs triggering on the merged interrupt line.

Aspect 5: The method of any of the preceding Aspects, further comprising receiving, from a source of the first triggered IRQ, a dynamically updated priority for a second triggered IRQ, in response to receiving the second triggered IRQ on the merged interrupt line.

Aspect 6: The method of any of the preceding Aspects, in which the source of the first triggered IRQ configures priorities for a plurality of different IRQs also received from the source of the first triggered IRQ.

Aspect 7: The method of any of the preceding Aspects, further comprising handling a plurality of IRQs on the merged interrupt line with a different priority for each of the plurality of IRQs.

Aspect 8: An apparatus for interrupt request (IRQ) prioritization, comprising: at least one memory; and at least one processor coupled to the at least one memory, the at least one processor configured: to receive, at a register space, from all sources of interrupts on a merged interrupt line, a priority for each of the interrupts on the merged interrupt line, the priorities being dynamically updated; to receive a first triggered IRQ on the merged interrupt line; to prioritize the first triggered IRQ in accordance with the priorities; and to service the first triggered IRQ in accordance with the priorities.

Aspect 9: The apparatus of Aspect 8, in which the at least one processor is further configured to receive, during system initialization, an initial configuration for the priorities of the interrupts on the merged interrupt line.

Aspect 10: The apparatus of Aspect 8 or 9, in which the priorities for each of the interrupts are received via packets on a separate line from the merged interrupt line.

Aspect 11: The apparatus of any of the Aspects 8-10, in which the at least one processor is further configured to receive a maximum priority of a plurality of priorities in response to multiple IRQs triggering on the merged interrupt line.

Aspect 12: The apparatus of any of the Aspects 8-11, in which the at least one processor is further configured to receive, from a source of the first triggered IRQ, a dynamically updated priority for a second triggered IRQ, in response to receiving the second triggered IRQ on the merged interrupt line.

Aspect 13: The apparatus of any of the Aspects 8-12, in which the source of the first triggered IRQ configures priorities for a plurality of different IRQs also received from the source of the first triggered IRQ.

Aspect 14: The apparatus any of the Aspects 8-13, in which the at least one processor is further configured to handle a plurality of IRQs on the merged interrupt line with a different priority for each of the plurality of IRQs.

Aspect 15: A non-transitory computer-readable medium having program code recorded thereon, the program code executed by a processor and comprising: program code to receive, at a register space, from all sources of interrupts on a merged interrupt line, a priority for each of the interrupts on the merged interrupt line, the priorities being dynamically updated; program code to receive a first triggered IRQ on the merged interrupt line; program code to prioritize the first triggered IRQ in accordance with the priorities; and program code to service the first triggered IRQ in accordance with the priorities.

Aspect 16: The non-transitory computer-readable medium of Aspect 15, in which the program code comprises program code to receive, during system initialization, an initial configuration for the priorities of the interrupts on the merged interrupt line.

Aspect 17: The non-transitory computer-readable medium of Aspect 15-16, in which the priorities for each of the interrupts are received via packets on a separate line from the merged interrupt line.

Aspect 18: The non-transitory computer-readable medium of any of the Aspects 15-17, in which the program code comprises program code to receive a maximum priority of a plurality of priorities in response to multiple IRQs triggering on the merged interrupt line.

Aspect 19: The non-transitory computer-readable medium of any of the Aspects 15-18, in which the program code comprises program code to receive, from a source of the first triggered IRQ, a dynamically updated priority for a second triggered IRQ, in response to receiving the second triggered IRQ on the merged interrupt line.

Aspect 20: The non-transitory computer-readable medium of any of the Aspects 15-19, in which the source of the first triggered IRQ configures priorities for a plurality of different IRQs also received from the source of the first triggered IRQ.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of interrupt request (IRQ) prioritization, comprising:
receiving, at a register space, from all sources of interrupts on a merged interrupt line, a priority for each of the interrupts on the merged interrupt line, the priorities being dynamically updated;
receiving a first triggered IRQ on the merged interrupt line;
prioritizing the first triggered IRQ in accordance with the priorities; and
servicing the first triggered IRQ in accordance with the priorities.

2. The method of claim 1, further comprising receiving, during system initialization, an initial configuration for the priorities of the interrupts on the merged interrupt line.

3. The method of claim 1, in which the priorities for each of the interrupts are received via packets on a separate line from the merged interrupt line.

4. The method of claim 1, further comprising receiving a maximum priority of a plurality of priorities in response to multiple IRQs triggering on the merged interrupt line.

5. The method of claim 1, further comprising receiving, from a source of the first triggered IRQ, a dynamically updated priority for a second triggered IRQ, in response to receiving the second triggered IRQ on the merged interrupt line.

6. The method of claim 5, in which the source of the first triggered IRQ configures priorities for a plurality of different IRQs also received from the source of the first triggered IRQ.

7. The method of claim 1, further comprising handling a plurality of IRQs on the merged interrupt line with a different priority for each of the plurality of IRQs.

8. An apparatus for interrupt request (IRQ) prioritization, comprising:
at least one memory; and
at least one processor coupled to the at least one memory, the at least one processor configured:
to receive, at a register space, from all sources of interrupts on a merged interrupt line, a priority for each of the interrupts on the merged interrupt line, the priorities being dynamically updated;
to receive a first triggered IRQ on the merged interrupt line;
to prioritize the first triggered IRQ in accordance with the priorities; and
to service the first triggered IRQ in accordance with the priorities.

9. The apparatus of claim 8, in which the at least one processor is further configured to receive, during system initialization, an initial configuration for the priorities of the interrupts on the merged interrupt line.

10. The apparatus of claim 8, in which the priorities for each of the interrupts are received via packets on a separate line from the merged interrupt line.

11. The apparatus of claim 8, in which the at least one processor is further configured to receive a maximum priority of a plurality of priorities in response to multiple IRQs triggering on the merged interrupt line.

12. The apparatus of claim 8, in which the at least one processor is further configured to receive, from a source of the first triggered IRQ, a dynamically updated priority for a second triggered IRQ, in response to receiving the second triggered IRQ on the merged interrupt line.

13. The apparatus of claim 12, in which the source of the first triggered IRQ configures priorities for a plurality of different IRQs also received from the source of the first triggered IRQ.

14. The apparatus claim 8, in which the at least one processor is further configured to handle a plurality of IRQs on the merged interrupt line with a different priority for each of the plurality of IRQs.

15. A non-transitory computer-readable medium having program code recorded thereon, the program code executed by a processor and comprising:
program code to receive, at a register space, from all sources of interrupts on a merged interrupt line, a priority for each of the interrupts on the merged interrupt line, the priorities being dynamically updated;
program code to receive a first triggered IRQ on the merged interrupt line;
program code to prioritize the first triggered IRQ in accordance with the priorities; and
program code to service the first triggered IRQ in accordance with the priorities.

16. The non-transitory computer-readable medium of claim 15, in which the program code comprises program code to receive, during system initialization, an initial configuration for the priorities of the interrupts on the merged interrupt line.

17. The non-transitory computer-readable medium of claim 15, in which the priorities for each of the interrupts are received via packets on a separate line from the merged interrupt line.

18. The non-transitory computer-readable medium of claim 15, in which the program code comprises program code to receive a maximum priority of a plurality of priorities in response to multiple IRQs triggering on the merged interrupt line.

19. The non-transitory computer-readable medium of claim 15, in which the program code comprises program code to receive, from a source of the first triggered IRQ, a dynamically updated priority for a second triggered IRQ, in response to receiving the second triggered IRQ on the merged interrupt line.

20. The non-transitory computer-readable medium of claim 19, in which the source of the first triggered IRQ configures priorities for a plurality of different IRQs also received from the source of the first triggered IRQ.
